(19) United States
(12) Patent Application Publication
(10) Pub. No.: US 2017/0358194 A1
(43) Pub. Date: Dec. 14, 2017

(54) Systems, Methods, and Apparatus for Sensing Environmental Conditions and Alerting a User in Response

(71) Applicant: The Boeing Company, Chicago, IL (US)

(72) Inventors: John William Glatfelter, West Chester, PA (US); Brian Dale Laughlin, Wichita, KS (US)

(73) Assignee: The Boeing Company, Chicago, IL (US)

(21) Appl. No.: 15/179,397

(22) Filed: Jun. 10, 2016

(51) Int. Cl. G08B 21/04; G08B 25/10; G01K 1/20; G01T 7/12; G01K 1/14; G08B 25/01; G01T 1/178

(52) U.S. Cl. CPC G08B 21/0469; G08B 25/016; G08B 25/10; G01T 1/178; G01T 7/12; G01K 1/14; G01K 1/20

(57) ABSTRACT

A system for monitoring one or more environmental conditions associated with a working environment includes a wearable device configured to be worn by a worker and one or more environmental sampling sensors configured to monitor the one or more environmental conditions associated with the working environment and determine environmental sampling information based on the monitoring of the one or more environmental conditions. The system further includes a positioning sensor configured to determine positioning information for the worker, the positioning information for the worker including information regarding positioning of the worker relative to the working environment. The system includes a controller configured to receive the environmental sampling information, receive the positioning information from the positioning sensor, and determine, based on the environmental sampling information and the positioning information, if the one or more environmental conditions necessitates an alert to be presented to the worker.

### TECHNICAL FIELD

The present disclosure relates generally to workplace monitoring and, more particularly, to systems, methods, and apparatus for location-based monitoring of environmental conditions associated with a workplace.

### BACKGROUND

Working environments often include a variety of activities occurring simultaneously, which can expose individuals to undesired conditions. Such working environments (e.g., a manufacturing environment) can present unique challenges for monitoring these conditions due to simultaneous existence of complex operations, workers and/or bystanders present in the environment, equipment within the environment, products within the environment, and processes within the environment, among other things, within the same working environment. Additional environmental factors, such as weather, terrain, ventilation, chemical and material presence, among other things, may also alter conditions of the working environment and introduce additional challenges.

These environmental factors of a working environment can create various effects on the environment, materials therein, and workers themselves. For efficiency and/or safety concerns, it is desired to effectively monitor such environmental conditions, as they relate to one or more workers within the working environment.

### SUMMARY

In accordance with one example, a system for monitoring one or more environmental conditions associated with a working environment is disclosed. The system includes a wearable device configured to be worn by a worker within the working environment and to move with the worker within the working environment. The system further includes one or more environmental sampling sensors operatively associated with the wearable device, each of the one or more environmental sampling sensors configured to monitor the one or more environmental conditions associated with the working environment and determine environmental sampling information based on the monitoring of the one or more environmental conditions. The system further includes a positioning sensor operatively associated with the wearable device and configured to determine positioning information for the worker, the positioning information for the worker including information regarding positioning of the worker relative to the working environment. The system further includes a controller, which includes a processor. The controller is configured to receive the environmental sampling information from the one or more environmental sampling sensors, receive the positioning information from the positioning sensor, and determine, based on the environmental sampling information and the positioning information, if the one or more environmental conditions necessitates an alert to be presented to the worker.

In accordance with another example, a wearable device for monitoring environmental conditions associated with a working environment is disclosed. The wearable device includes a wearable article configured to be worn by a worker and to move with the worker. The wearable device further includes one or more modular environmental sampling sensors operatively associated with the wearable article, each of the one or more modular environment sensors configured to monitor the one or more environmental conditions associated with the working environment and determine environmental sampling information based on the monitoring of the one or more environmental conditions. The wearable device further includes a positioning sensor operatively affixed to the wearable article and configured to determine positioning information for the worker, the positioning information for the worker including information regarding positioning of the worker relative to the working environment. The wearable device further includes one or more output devices operatively associated with the wearable article and configured to receive an output signal and present a notification to the worker based on the output signal. The wearable device further includes a controller, which includes a processor, and is operatively associated with the modular environmental sampling sensors, the positioning sensor, and the one or more output devices. The controller is configured to receive the environmental sampling information from the one or more environmental sampling sensors, receive the positioning information from the positioning sensor, determine, based on the environmental sampling information and the positioning information, if the one or more environmental conditions necessitates an alert to be presented to the worker, and provide the output signal to the one or more output devices if the one or more environmental conditions necessitates the alert be presented to the worker.

In accordance with yet another example, a method for monitoring environmental conditions associated with a working environment in relation to a worker within the working environment is disclosed. The method includes monitoring the one or more environmental conditions using one or more environmental sampling sensors, each of the one or more environmental sampling sensors being operatively associated with a wearable device configured to be worn by the worker within the working environment. The method further includes determining environmental sampling information based on the monitoring of the one or more environmental conditions using the one or more environmental sampling sensors. The method further includes determining positioning information for the worker using a positioning sensor operatively associated with the wearable device, the positioning information including information regarding positioning of the worker relative to the working environment. The method further includes receiving, by a controller having a processor, the environmental sampling information from the environmental sampling sensors and receiving the positioning information from the positioning sensor. The method further includes determining, by the controller, if the one or more environmental conditions necessitates an alert be presented to the worker, based on the environmental sampling information and the positioning information and providing an alert to the worker if the one or more environmental conditions necessitates an alert be presented to the worker.

These and other aspects and features will become more readily apparent upon reading the following detailed description when taken in conjunction with the accompanying drawings. In addition, although various features are disclosed in relation to specific examples, it is understood that the various features may be combined with each other, or used alone, with any of the various examples without departing from the scope of the disclosure.

### BRIEF DESCRIPTION OF THE DRAWINGS

FIG. 1 is a schematic diagram of a system for monitoring one or more environmental conditions associated with a working environment, in accordance with the disclosure;

FIG. 2 is a schematic block diagram depicting elements of, or associated with, a wearable device used by the system of FIG. 1, in accordance with FIG. 1 and the disclosure;

FIG. 3 is a diagrammatic depiction of a wrist band for use as a wearable device, in accordance with the disclosure;

FIG. 4 is a diagrammatic depiction of a belt for use as a wearable device, in accordance with the disclosure;

FIG. 5, is a diagrammatic depiction of a modular sleeve for use as a wearable device, in accordance with the disclosure;

FIG. 6 is a diagrammatic depiction of headwear for use as a wearable device, in accordance with the disclosure;

FIG. 7 is a schematic diagram of a system for monitoring one or more environmental conditions associated with a working environment, in which multiple workers inhabit the working environment, in accordance with the disclosure;

FIG. 8 is an exemplary flowchart for a method for monitoring environmental conditions associated with a working environment in relation to a worker within the working environment, in accordance with the present disclosure; and

FIG. 9 is a schematic diagram for an exemplary computer that may execute instructions for providing the exemplary systems and methods of the present disclosure.

While the present disclosure is susceptible to various modifications and alternative constructions, certain illustrative examples thereof will be shown and described below in detail. The disclosure is not limited to the specific examples disclosed, but instead includes all modifications, alternative constructions, and equivalents thereof.

### DETAILED DESCRIPTION

Reference will now be made in detail to specific examples or features, which are illustrated in the accompanying drawings. Generally, corresponding reference numbers will be used throughout the drawings to refer to the same or corresponding parts.

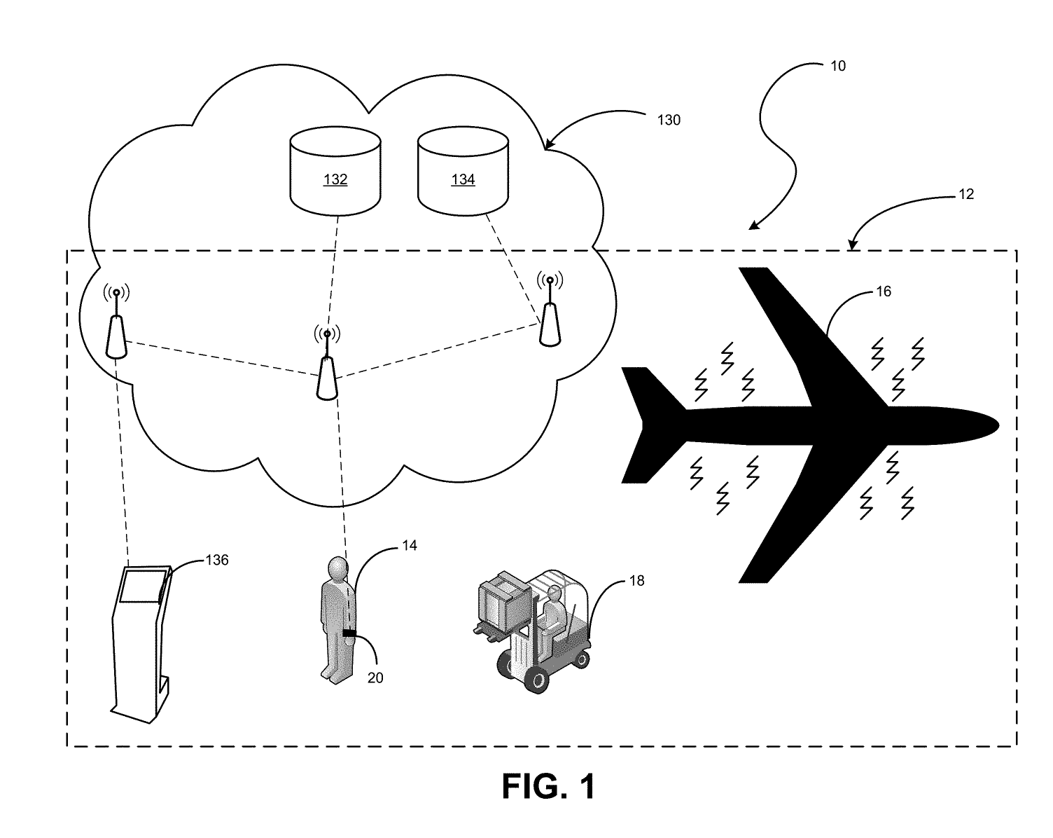

FIG. 1 illustrates an exemplary system 10 for monitoring environmental conditions of a working environment 12, with respect to a worker 14. The worker 14, as defined herein, is any human within the working environment 12 in any capacity (e.g., working, manufacturing, managing, observing, reporting, monitoring, resting, or any other active or passive activity). As defined herein, an “environmental condition with respect to the worker” may be any condition or occurrence within the working environment 12 that can affect the worker 14 in any way, be it a health related condition, a safety related condition, a proximity related condition, or any other condition. In one non-limiting example, environmental conditions include electrical feedback generated by operation of, or operation in service of, a machine 16. Another example environmental condition is proximity of the worker 14 to a mobile working machine 18. Further, in some examples, environmental conditions with respect to the user include environmental factors which can affect the health of the worker 14.

To participate in monitoring such environmental conditions within the working environment 12, the system 10 includes a wearable device 20. The wearable device 20 is configured to be worn by the human worker 14, while the worker 14 is within the working environment 12. As the wearable device 20 is to be worn by the worker 14 when performing any active or passive task within the working environment 12, positioning of the wearable device 20 is associated with positioning of the worker 14 within the working environment 12. The wearable device 20 can take the form of, or be affixed to, various wearable articles (jewelry, bracelets, headwear, accessories, eyewear, functional attire, etc.), as discussed in more detail below. Additionally, in some examples, the wearable device 20 is configured and/or configurable to communicate with other elements of the system 10 via any wired or wireless means, as discussed in more detail below.

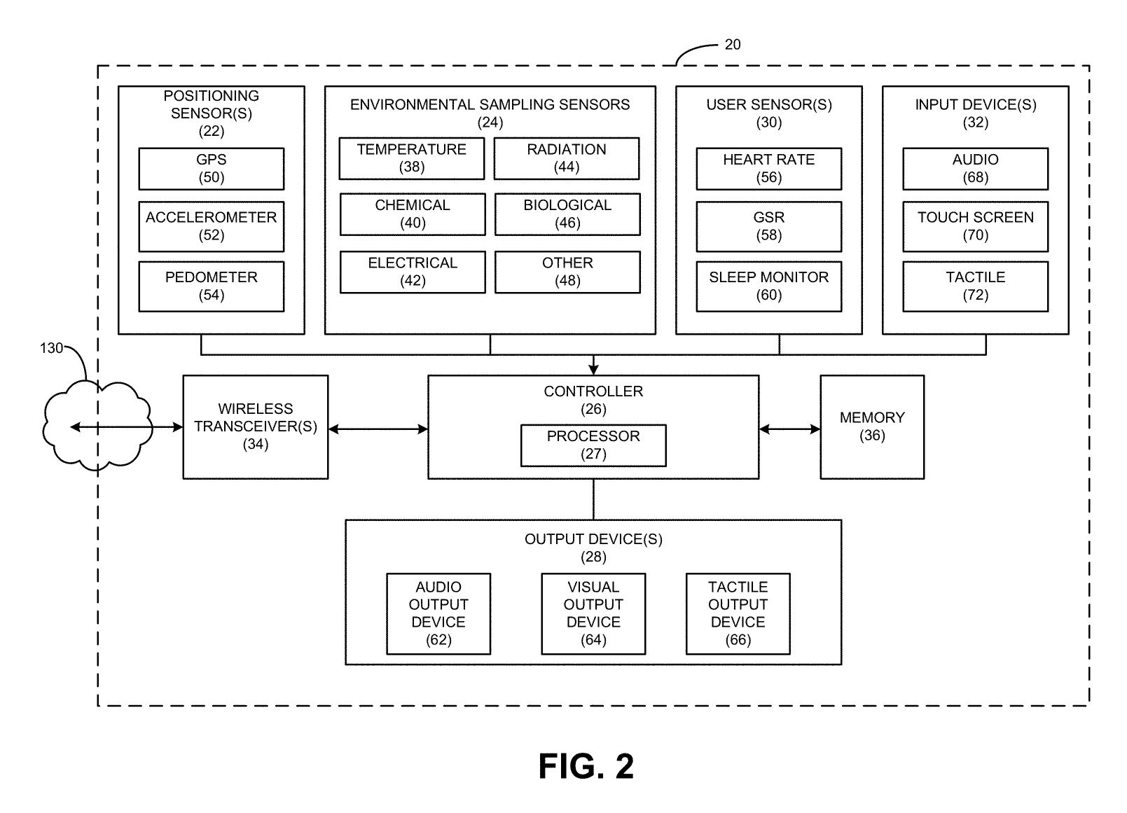

Turning to FIG. 2 and with continued reference to FIG. 1, a schematic diagram of the wearable device 20 is shown. While the elements of FIG. 2 are depicted as schematically encompassed by the wearable device 20, in some examples, some elements in the schematic depiction of the wearable device 20 are not physically located on or implemented as a part of the wearable device 20, but are, instead, operatively associated with the wearable device 20 and/or the worker 14 who is using the wearable device 20. As such, the schematic depiction of the wearable device 20 of FIG. 2 is intended to illustrate elements of or elements associated with the wearable device 20, which are used in conjunction to embody the systems and to perform the methods of the present disclosure.

The wearable device 20 includes, at least, positioning sensor(s) 22, environmental sampling sensor(s) 24, a controller 26, and output device(s) 28. In some examples, the wearable device 20 includes one or more of user sensor(s) 30, input device(s) 32, wireless transceiver(s) 34, and a memory 36. By utilizing the elements of the wearable device 20, the system 10 is capable of determining existence of one or more environmental conditions and positioning of the worker 14. In some examples, by using said information, the system 10 generates an output signal, if at least one of the one or more environmental conditions exists and it is deemed necessary to issue an alert to the worker 14, in response to the one or more environmental conditions.

The environmental sampling sensors 24 are operatively associated with the wearable device 20. The environmental sampling sensors 24 include one or more modular sensors configured to be added or removed from the system 10, based on system 10 need (e.g., “plug-and-play” type sensors). Utilizing modular sensors for environmental sampling sensors 24 may allow customizability for environmental condition monitoring performed by the system 10. Additionally or alternatively, the environmental sampling sensors 24 may include one or more sensors permanently affixed to the wearable device 20 and/or one or more of the environmental sampling sensors 24 may not be affixed to the wearable device 20 and may communicate with the wearable device 20, as he/she exists in the working environment 12. Further, in some examples, one or more of the environmental sampling sensors 24 may be sensors classified as “Internet of Things” (IoT) sensors.

Each of the environmental sampling sensors 24 are configured to monitor one or more environmental conditions associated with the working environment 12 and determine environmental sampling information based on such monitoring of the one or more environmental conditions. The environmental sampling sensors may operate independently, cooperatively, or both. For example, a temperature sensor 38 of the environmental sampling sensors 24 may monitor temperature-related environmental conditions (e.g., heat proximate to the worker 14), and said conditions may be indicative of a temperature-related environmental state within the working environment 12 that necessitates an alert be presented to the worker 14 (e.g., excessive heat or cold within the working environment 12 that may be harmful to the worker 14 and/or equipment within the working environment 12).

In some examples, the environmental sampling sensors 24 may also additionally or alternatively include chemical sensor(s) 40, which are configured to detect chemicals within the work environment and conditions related to chemicals as chemical-based environmental conditions that necessitate an alert be presented to the worker 14 (e.g., excessive parts per square inch of a chemical within the environment, excessive levels of chemicals in the atmosphere or ground, lack of oxygen, presence of carbon monoxide, excess of carbon dioxide, or any other chemical condition within the working environment 12).

In addition to or alternatively to the environmental sampling sensors described above, other example environmental sampling sensors 24 include, but are not limited to, electrical sensors 42, radiation sensors 44, biological sensors 46, and/or any other sensors 48. Electrical sensors 42 are configured to determine the presence of electrical conditions within the working environment 12 (e.g., electrical fields, electrical currents, at the like). Accordingly, electrical sensors 42 are configured to detect electric currents/fields within the work environment and conditions related to electricity and electrical-based environmental conditions that necessitate an alert be presented to the worker 14 (e.g. elevated electrical currents or fields in an environment, presence of exposed electrical wiring causing increases in electrical properties, and the like). In one example, the machine 16 of the working environment 12 may produce high electrical currents that are undesirable when in the presence of the worker 14. In such examples, the electrical sensor 42 may detect excessive electrical current in the working environment 12, or portions thereof, and alert the worker 14 to keep his/her distance from the machine 16.

In addition to or alternatively the environmental sampling sensors 24 may include the radiation sensor 44, the radiation sensor 44 is configured to determine the presence of radiation and/or radioactive materials and evaluate conditions associated with radiation and/or radioactive materials. Accordingly, the radiation sensor 44 determines one or both of immediate presence of radiation, with respect to the user, and cumulative presence of radiation, with respect to the worker 14. If either immediate or cumulative presence of radiation is at an unacceptable level, with respect to the worker 14, then such presence is an environmental condition that necessitates an alert be presented to the worker 14.

To determine positioning information associated with the worker 14, the system 10 includes the positioning sensor(s) 22. The positioning sensors 22 sense the position of the worker 14 relative to the associated working environment 12. The positioning sensors 22 include one or more of individual sensors that cooperate to provide signals to the controller 26 to indicate the position of the worker 14 and/or determine characteristics of a motion of the worker 14, within the working environment 12. In some examples, the positioning sensor(s) 22 include one or more global positioning system (GPS) sensors 50 for detecting positioning of the worker 14 relative to the working environment 12. In some examples, the positioning sensors 22 include one or both of an accelerometer 52 and a pedometer 54. Of course, other elements aiding in detecting positioning of the worker 14 relative to the working environment 12 may be included.

To gather information associated with the worker 14 and, particularly, health of the worker 14, the system 10, in some examples, includes the user sensors 30. The user sensors 30 are any sensors configured for monitoring conditions directly associated with the worker 14, such as, but not limited to, health information associated with the worker 14. As such, the user sensors 30 are configured to generate health information associated with the worker 14.

In the non-limiting example presented herein, the user sensors 30 include a heart rate monitor 56, a galvanic skin response sensor (GSR) 58, and a sleep monitor 60, among other things. All such user sensors 30 are configured to capture data which is indicative of health conditions associated with the worker 14 (e.g., heart rate information from the heart rate monitor 56, electrodermal activity from the GSR sensor 58, sleep duration and/or sleep quality data from the sleep monitor 60, among other things). Of course, the health information gathered by the user sensors 30 is capable of including body temperature information for the worker 14, blood alcohol content (BAC) information of the worker 14, blood pressure of the worker 14, and any other health condition associated with the worker 14.

The controller 26, which includes a processor 27, receives as signals, at least, the environmental sampling information determined by the environmental sampling sensors 24 and the positioning information determined by the positioning sensors 22. Optionally, in some examples, the controller 26 receives the health information determined by the user sensors 30 or receives health information stored on a health information database. Based on the environmental sampling information, the positioning information, and, optionally, the health information, the controller 26 determines if the one or more environmental conditions necessitates an alert to be presented to the user via, for example, the output device(s) 28. For example, the environmental sampling information received by the controller 26 may indicate that the worker 14 is experiencing a high level of electrical current at his/her person and, based on the positioning information provided in conjunction with the environmental conditions, the controller 26 determines that the worker 14 is too close to the machine 16. Therefore, the controller 26 determines that the environmental conditions necessitate an alert for the worker 14. In some examples, the an output signal is provided by the controller 26 to the output devices 28, to provide the worker 14 with an alert regarding the environmental conditions (e.g., in the case of the electrical current, the controller, for example, indicates that the worker 14 is too close to the machine 16). In some examples, once the output device(s) 28 have issued the alert, the controller 26 receives an input signal, in response to the output signal, from the input device(s) 32, indicating that the worker 14 has received and/or acknowledged the alert.

The controller 26 is any electronic controller or computing system including a processor (e.g., the processor 27) which performs operations, executes control algorithms, stores data, retrieves data, gathers data, and/or performs any other computing or controlling task desired. The controller 26 may be a single controller or may include more than one controller disposed to control various functions and/or features of the system 10. Functionality of the controller 26 may be implemented in hardware and/or software and may rely on one or more data maps relating to functions of the system 10. To that end, the controller 26 may include internal memory 36 and/or the controller 26 may be otherwise connected to external memory, such as a database or server, via any wired or wireless networks. The memory 36 may include, but is not limited to including, one or more of read only memory (ROM), random access memory (RAM), a portable memory, and the like. Such memory media are examples of nontransitory memory media.

The controller 26 is capable of registering a location of the worker 14, using the positioning data and, optionally, time stamping said location data. The controller 26, in some examples, also can register the worker 14 in accordance with a current task. Further, the controller 26, in some examples, is configured to perform one or more of the following functions: authenticating the worker 14 for a task, clock the worker 14 on or off the working environment 12 or a task, check training records for the worker 14, and/or certifying the worker's qualifications for performing a task in the working environment 12. In such examples, such tasks are either performed at the controller 26, in communication with the memory 36, or the tasks are performed by the controller 26 in conjunction with one or more other controllers, databases, servers, and the like, which are in communication with the controller 26 via a network.

As discussed above, in some examples, if one or more environmental conditions are monitored and the controller 26 determines that said condition(s) necessitate an alert be presented to the worker 14, the alert is presented to the worker 14 via one or more output devices 28. The output devices 28 include one or more of an audio output device 62, a visual output device 64, a tactile output device 66, or a combination thereof. The audio output device 62 is any audio device capable of providing an audible signal to the worker 14 like, for example, a speaker. Such audible signals may be any audible noise of any amplitude, configured to alert the worker 14, in response to an output signal from the controller 26. The visual output device 64 is any light, screen, or visual device which may be configured to provide the worker 14 with any form of visual stimuli, in response to an output signal from the controller 26.

Further, the tactile output device 66 is any vibratory and/or haptic device configured to alert the worker 14 via one or more vibrations, in response to an operator alert signal. The tactile output device 66 is embedded in the wearable device 20, such that the tactile output device 66 will provide a vibratory alert to the worker 14 via the wearable device 20. Of course, additionally or alternatively, the tactile output device 66 may located anywhere within the working environment 12, wherein vibratory signals from the device will reach the worker 14. Additionally, output of the tactile output device 66 may be any vibration pattern, increasing or decreasing level of vibration, rhythmic vibration, or any other signifying vibration indicative of one or more environmental conditions.

In some examples of the system 10, it is desired that the worker 14 respond to the notification provided by the output device(s) 28. In such examples, the system 10 may further include one or more input device 32, configured to generate an input signal from the worker 14 in response to recognition, by the worker 14, of the notification signal. For example, the audio output device 62 may produce an audible signal telling the user “Stop,” and, in response, an input device 32, such as a microphone 68, generates an input signal from spoken words by the worker 14, confirming he/she has stopped (e.g., the worker 14 responding to “Stop,” from the audio output device 62, with “okay”). In some examples, the input devices 32 include one or more of the microphone 68, a touch screen 70, and tactile input sensor 72, among other possible input devices.

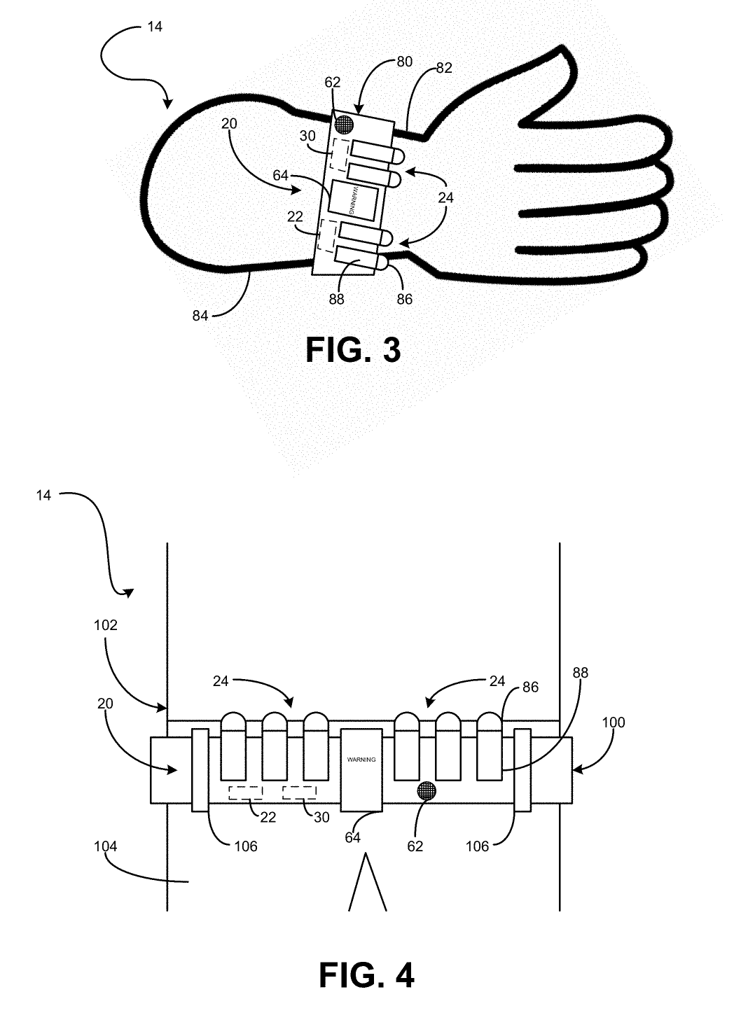

As discussed above, the wearable device 20 can take the form of, or be affixed to, various wearable articles. Examples of such wearable articles are illustrated in FIGS. 3-6 and described in more detail below. While the examples of FIGS. 3-6 illustrate examples directed towards four different wearable articles, it is certainly possible that the systems and methods of the present disclosure can be accomplished by utilizing any wearable article, on which the wearable device 20 is capable of being implemented.

Beginning with FIG. 3, a wrist band 80 is depicted, in which the wrist band 80 is implemented to embody, house, encase, or otherwise be functionally associated with the wearable device 20. The wearable device 20 is mounted to, attached to, embedded within, or otherwise affixed to the wrist band 80. As shown, the wrist band 80 is configured to be worn by the worker 14 on a wrist 82, or other portion, of an arm 84 of the worker 14.

Accordingly, the wrist band 80 is operatively associated with the position sensor(s) 22 of the wearable device 20, as to accurately track positioning of the worker 14 who is wearing the wrist band 80. Additionally, the wrist band 80 is operatively associated with one or more environmental sampling sensors 24. The environmental sampling sensors 24 may include modular sensors 86. In some examples, the modular sensors 86 are plugged into and taken out of modular sensor ports 88, enabling a “plug and play” aspect to the environmental sampling sensors 24. Additionally, output device(s) 28 of the wearable device 20 are operatively associated with the wrist band 80 and, for example, include a visual output device 64 and audio output device 62.

Turning now to FIG. 4, a belt 100 is depicted, in which the belt 100 is implemented to embody, house, encase, or be otherwise functionally associated with the wearable device 20. The wearable device 20 is mounted to, attached to, embedded within, or otherwise affixed to the belt. As shown, the belt 100 is configured to be worn by the worker 14 on a mid-section 102 (e.g., a waist, a natural waist, a chest, or any portion thereof). In some examples, the belt 100 is worn in conjunction with pants 104 that are worn by the worker 14 and the belt 100 is, optionally, supported by belt loops 106.

To track the positioning of the worker 14 who is wearing the belt 100, the belt 100 is operatively associated with the position sensor(s) 22 of the wearable device 20. Additionally, the belt 100 is operatively associated with one or more environmental sampling sensors 24. In some examples, the environmental sampling sensors 24 include modular sensors 86. In some examples, the modular sensors 86 are plugged into and taken out of modular sensor ports 88, enabling a “plug and play” aspect to the environmental sampling sensors 24. Additionally, output device(s) 28 of the wearable device 20 are operatively associated with the wrist band 80 and, for example, include a visual output device 64 and audio output device 62.

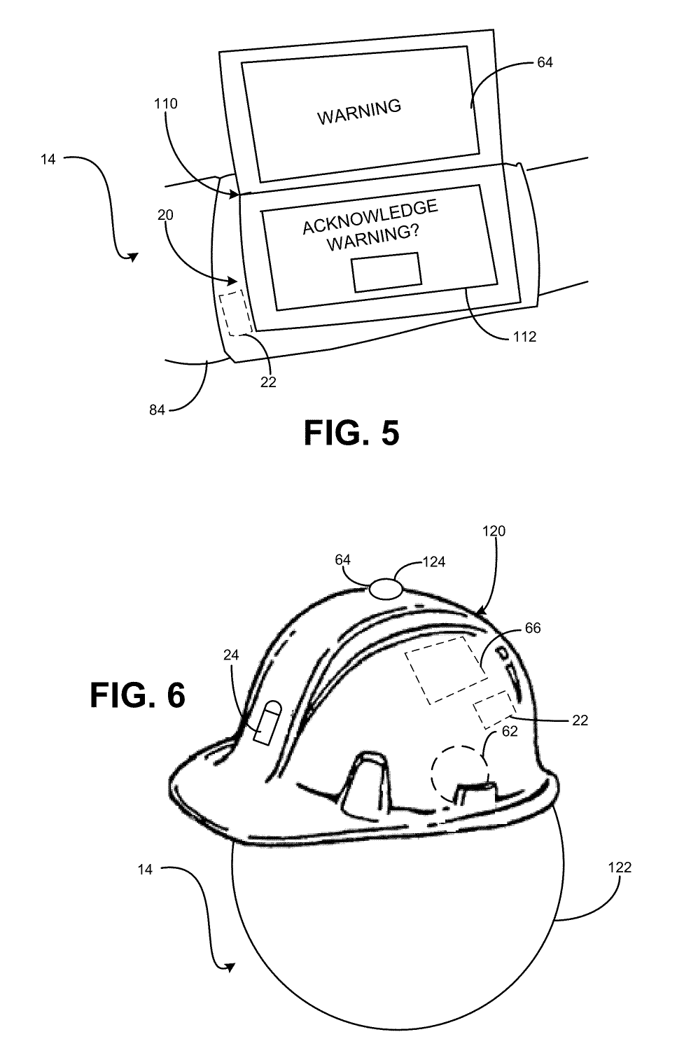

FIG. 5 illustrates yet another example of a wearable article for use with, or as, the wearable device 20, in which a modular sleeve 110 is depicted. The modular sleeve 110 is implemented to embody, house, encase, or otherwise be functionally associated with the wearable device 20. In some examples, the wearable device 20 is mounted to, attached to, embedded within, or otherwise affixed to the modular sleeve 110. As shown, the modular sleeve 110 is configured to be worn by the worker 14 on the arm 84 of the worker 14. The modular sleeve 110 is configured to expand or retract, in response to size of the arm 84 and/or changes in movement of the arm 84.

Accordingly, the modular sleeve 110 is operatively associated with the position sensor(s) 22 of the wearable device 20, as to accurately track positioning of the worker 14 who is wearing the modular sleeve 110. Additionally, the modular sleeve 110 is operatively associated with one or more environmental sampling sensors 24 (not shown). Further, output device(s) 28 of the wearable device 20 are operatively associated with the modular sleeve 110 and, for example, include a visual output device 64. The modular sleeve 110 may include input device(s) 32, such as a touch screen 112. The touch screen 112 is used to respond to and/or acknowledge alerts presented via the output device(s) 28, such as the visual output device 64.

In FIG. 6, headwear 120, such as a hardhat, bump-cap, or any other headwear, is depicted, in which the headwear 120 is implemented to embody, house, encase, or otherwise functionally associate with the wearable device 20. The wearable device 20 is mounted to, attached to, embedded within, or otherwise affixed to the headwear 120. As shown, the headwear 120 is configured to be worn by the worker 14 on a head 122 of the worker 14.

Accordingly, the headwear 120 is operatively associated with the position sensor(s) 22 of the wearable device 20, as to accurately track positioning of the worker 14 who is wearing the headwear 120. Additionally, the headwear 120 is operatively associated with one or more environmental sampling sensors 24. In some examples, the environmental sampling sensors 24 include modular sensors 86. In some examples, the modular sensors 86 are plugged into and taken out of modular sensor ports 88, enabling a “plug and play” aspect to the environmental sampling sensors 24. Further, the headwear 120, in some examples, is operatively associated with output devices 28. Some example output devices 28 for implementation with the headwear 120 include, but are not limited to including, an audio output device 62 positioned in proximity to an ear of the worker 14 when the worker 14 wears the headwear 120 on his/her head 122, a tactile output device 66 embedded within the headwear 120, and a visual output device 64, such as a light 124, configured to present visual stimuli to the worker 14 in response to an alert from the controller 26.

Returning now to FIG. 1, the wearable device 20 and/or the controller 26 are connected to other elements of the system 10 via a wireless network 130. The wireless network 130 is configured to connect the worker 14, via the wearable device 20, to any other workers 14 having their own wearable devices 20, to any databases, such as a user information database 132 and a user health information database 134, and to a worker kiosk 136, among other things. The worker kiosk is 136 is configured to check the worker 14 into the working environment 12 via the wearable device 20 and configured to store and transmit data via the wireless network 130.

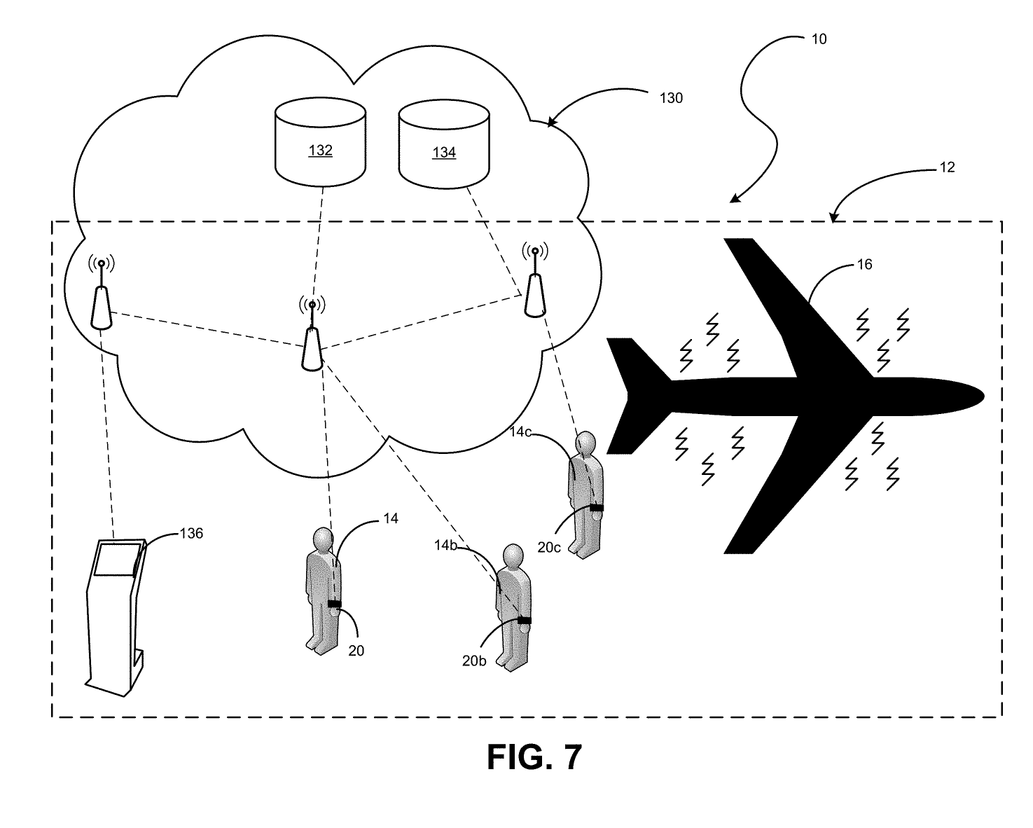

As discussed above, the working environment 12 often includes multiple workers 14 performing the same or different tasks. In such examples, like the example working environment 12 employing the system 10 of FIG. 7, multiple workers 14a, 14b, 14c are connected via their respective wearable devices 20a, 20b, 20c over the wireless network 130. Each of the wearable devices 20a, 20b, 20c are functionally embodied by the teachings of the wearable device 20, as detailed above. In such scenarios wherein multiple workers 14 are present at the working environment 12, each wearable device 20 can receive positioning information associated with other wearable devices 20. For example, the second worker 14b is wearing a second wearable device 20b and the second wearable device 20b provides positioning information to the controller 26 of the first wearable device 20. By receiving and utilizing such positioning information from the second wearable device 20b via the wireless network 130, the controller 26 of the first wearable device 20a determines positioning information associated with the second worker 14b. Additionally, the controller 26 can receive environmental sampling information from the second wearable device 20b, determined from environmental sampling sensors 24 of the second wearable device 20b. Utilizing positioning information and environmental sampling information from the second wearable device 20b, the controller 26 of the first wearable device 20a determines if environmental conditions affecting the second worker 14b necessitates that an aid alert be presented to the first worker 14a. The aid alert indicates that the second worker 14b is in need of aid (e.g., the second worker 14b is immobile, the second worker 14b is too close to a hazardous condition, etc.).

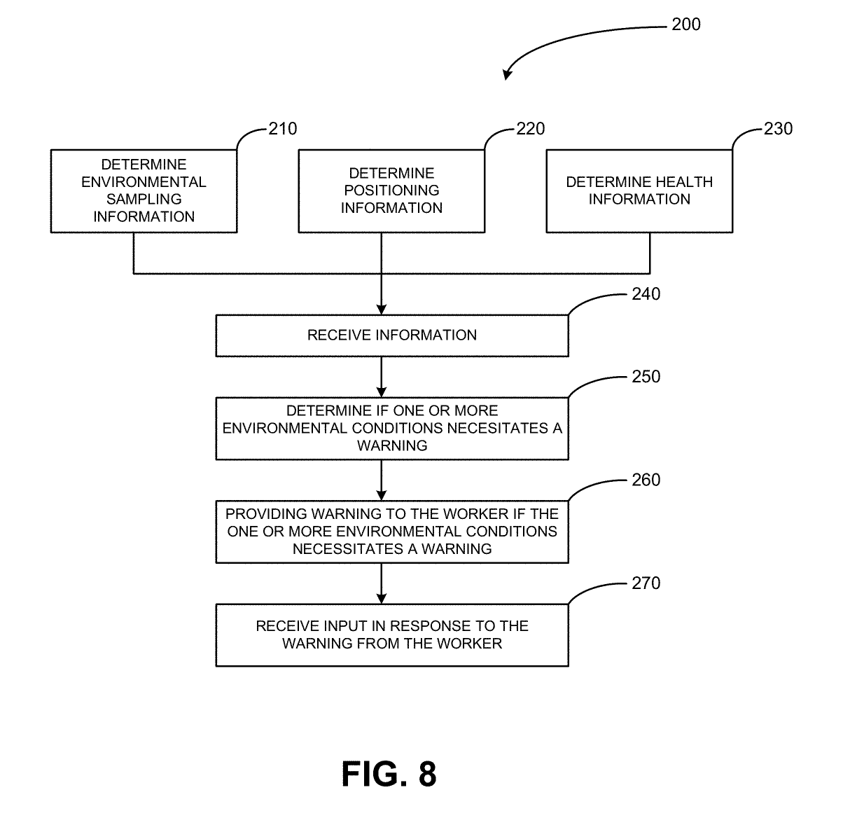

Turning now to FIG. 8, an example flowchart for a method 200 for monitoring environmental conditions associated with a working environment is shown. The method 200 will be described herein with reference to elements of the system 10 and their respective functions; however, the method 200 is certainly not limited to being implemented via the system 10 and its included elements.

The method 200 begins at blocks 210-230. At block 210, the environmental sampling sensors 24 monitor one or more environmental conditions and, based on said monitoring, determine environmental sampling information. At block 220, positioning information for the worker 14 is determined using the positioning sensor(s) 22, wherein the positioning information includes information regarding positioning of the worker 14 relative to the working environment 12. At the optional block 230, the method 200 includes determining health information for the worker 14 using one or more user sensors 30. Additionally or alternatively, in some examples, health information is provided from a database.

At block 240, the controller 26 receives the environmental sampling information, the positioning information and, optionally, the health information. Using the information received, the controller 26 determines if the one or more environmental conditions necessitates an alert be presented to the worker 14, as shown in block 250. If it is determined that the one or more environmental conditions necessitates an alert be presented to the worker 14, then an alert is provided to the worker 14 via, for example, one or more output devices 28, as shown in block 260. In some examples, the method 200 further includes receiving input in response to the alert from the worker 14 to, for example, acknowledge the alert was received, as shown in block 270.

It is to be understood that the flowchart of FIG. 8 is shown and described as an example only to assist in disclosing the features of the disclosed system and techniques, and that more or less steps than that shown may be included in the process corresponding to the various features described above for the disclosed system without departing from the scope of the disclosure.

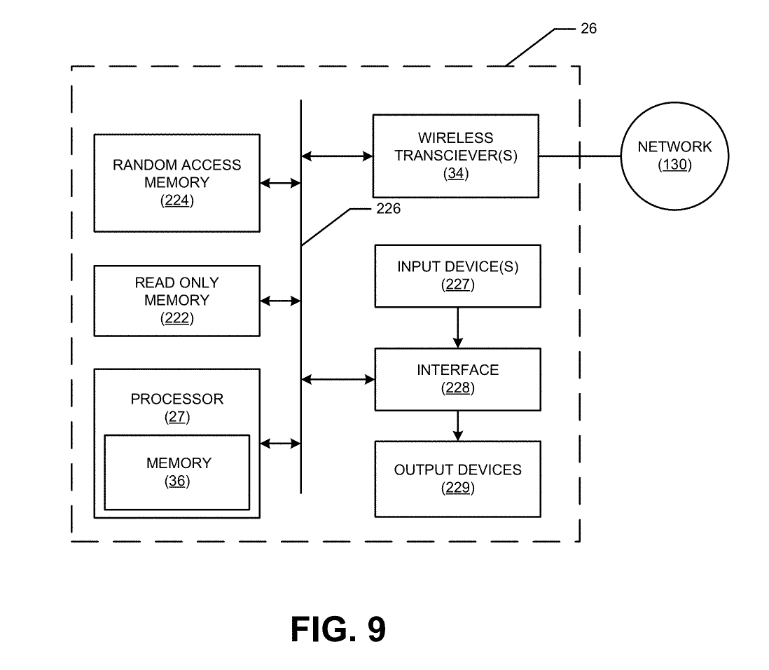

FIG. 9 schematically illustrates a combination of example elements which may be used to implement the controller 26 of the system 10, as shown in FIG. 2. The exemplary controller 26 is capable of executing instructions to realize the functions of the system 10 and/or execute instructions to perform the method 200, discussed above in reference to FIG. 8. The controller 26 may be, for example, a server, a personal computer, or any other type of computing device. The controller 26 of the instant example includes the processor 27. For example, the processor 27 may be implemented by one or more microprocessors or controllers from any desired family or manufacturer.

The processor 27 is associated with a memory 36 and is in communication with other memory including a read only memory 222 and a random access memory 224 via a bus 226. The random access memory 224 may be implemented by Synchronous Dynamic Random Access Memory (SDRAM), Dynamic Random Access Memory (DRAM), RAMBUS Dynamic Random Access Memory (RDRAM) and/or any other type of random access memory device. The read only memory 222 may be implemented by a hard drive, flash memory and/or any other desired type of memory device.

In some examples, the controller 26 includes an interface circuit 228. The interface circuit 128 may be implemented by any type of interface standard, such as, for example, an Ethernet interface, a universal serial bus (USB), and/or a PCI express interface. One or more input devices 227 are connected to the interface circuit 128. The input device(s) 227 permit a user to enter data and commands into the processor 27. The input device(s) 227 can be implemented by, for example, a keyboard, a mouse, a touchscreen, a track-pad, a trackball, and/or a voice recognition system. For example, the input device(s) 227 may include any wired or wireless device for connecting inputting data in to the controller 26 in response to an alert, as described above.

The output devices 229 are also connected to the interface circuit 228. The output devices 229 are implemented by any example output device (e.g., the output device(s) 28), as discussed above

Further, in some examples, the controller 26 includes one or more wireless transceivers 34 for connecting to a network 130, such as the Internet, a WLAN, a LAN, a personal network, or any other network for connecting the controller 26 to one or more other controllers or network capable devices. As such, the controller 26 may be embodied by a plurality of controllers 26 for controlling various elements of the system 10.

As mentioned above the controller 26 may be used to execute machine readable instructions. For example, the controller 26 executes machine readable instructions to perform the method 200 shown in the block diagrams of FIG. 8. In such examples, the machine readable instructions comprise a program for execution by a processor, such as the processor 27, shown in the example controller 26. The program may be embodied in software stored on a tangible computer readable medium such as a CD-ROM, a floppy disk, a hard drive, a digital versatile disk (DVD), a Blu-ray disk, or a memory associated with controller 26, but the entire program and/or parts thereof could alternatively be executed by a device other than the processor 27 and/or embodied in firmware or dedicated hardware. Further, although the example programs are described with reference to the flowcharts illustrated in FIG. 8, many other methods of implementing examples of the present disclosure may alternatively be used. For example, the order of execution of the blocks may be changed, and/or some of the blocks described may be changed, eliminated, or combined.

1. A system for monitoring one or more environmental conditions associated with a working environment, the system comprising:
a wearable device, the wearable device configured to be worn by a worker within the working environment and to move with the worker within the working environment;
one or more environmental sampling sensors operatively associated with the wearable device, each of the one or more environmental sampling sensors configured to monitor the one or more environmental conditions associated with the working environment and determine environmental sampling information based on the monitoring of the one or more environmental conditions;
a positioning sensor operatively associated with the wearable device and configured to determine positioning information for the worker, the positioning information for the worker including information regarding positioning of the worker relative to the working environment; and
a controller, including a processor, configured to receive the environmental sampling information from the one or more environmental sampling sensors, receive the positioning information from the positioning sensor, and determine, based on the environmental sampling information and the positioning information, whether an alert is to be presented to the worker, the controller being further configured to determine, based at least in part on the environmental sampling information, whether to wirelessly transmit an alert to a second wearable device worn by a second worker, indicative of the worker being in need of aid.

2. The system of claim 1, further comprising one or more output devices operatively associated with the wearable device and the controller and configured to receive an output signal from the controller and present a notification to the worker based on the output signal, and wherein the controller is further configured to generate the output signal if the one or more environmental conditions necessitates the alert to be presented to the worker.

3. The system of claim 2, further comprising one or more input devices operatively associated with the controller and configured to generate an input signal based on input from the worker, wherein the controller is further configured to receive the input signal, the input signal being in response to the output signal.

4. The system of claim 2, wherein the one or more output devices include at least one of a visual output device, an audio output device, a tactile output device, and any combinations thereof and the notification includes at least one of a visual notification, an audio notification, a tactile notification, and any combinations thereof.

5. The system of claim 1, wherein at least one of the one or more environmental sampling sensors is a modular sensor configured to be added and removed from the system.

6-7. (canceled)

8. The system of claim 1, further comprising one or more user sensors operatively associated with the wearable device and configured to generate health information associated with the worker, and wherein the controller is further configured to determine if the one or more environmental conditions necessitates the alert to be presented to the worker based on the health information.

9. The system of claim 1, further comprising a health information database operatively associated with the wearable device and configured to store health information associated with the worker, and wherein the controller is further configured to determine if the one or more environmental conditions necessitates the alert be presented to the worker based on the health information.

10. The system of claim 1, wherein the one or more environmental sampling sensors include a chemical sensor configured to detect chemical-based environmental conditions, and wherein the controller is configured to receive the chemical-based environmental conditions from the chemical sensor, and determine, based on the chemical-based environmental conditions and the positioning information, if the chemical-based environmental conditions necessitates the alert be presented to the worker.

11. The system of claim 1, wherein the one or more environmental sampling sensors include an electrical sensor configured to detect electrical environmental conditions, and wherein the controller is configured to receive the electrical environmental conditions from the electrical sensor, and determine, based on the electrical environmental conditions and the positioning information, if the electrical environmental conditions necessitates the alert be presented to the worker.

12. The system of claim 1, wherein the one or more environmental sampling sensors include a temperature sensor configured to detect heat-based environmental conditions, and wherein the controller is configured to receive the heat-based environmental conditions from the temperature sensor, and determine, based on the heat-based environmental conditions and the positioning information, if the heat-based environmental conditions necessitates the alert be presented to the worker.

13. The system of claim 1, wherein the one or more environmental sampling sensors include a radiation sensor configured to detect radiation-based environmental conditions, and wherein the controller is configured to receive the radiation-based environmental conditions from the radiation sensor, and determine, based on the radiation-based environmental conditions and the positioning information, if the radiation-based environmental conditions necessitates the alert be presented to the worker.

14. A wearable device for monitoring environmental conditions associated with a working environment, the wearable device comprising:
a wearable article configured to be worn by a worker and to move with the worker;
one or more modular environmental sampling sensors operatively associated with the wearable article, each of the one or more modular environment sensors configured to monitor the one or more environmental conditions associated with the working environment and determine environmental sampling information based on the monitoring of the one or more environmental conditions;
a positioning sensor operatively affixed to the wearable article and configured to determine positioning information for the worker, the positioning information for the worker including information regarding positioning of the worker relative to the working environment;
one or more output devices operatively associated with the wearable article and configured to receive an output signal and present a notification to the worker based on the output signal, and
a controller, including a processor, operatively associated with the modular environmental sampling sensors, the positioning sensor, and the one or more output devices and configured to receive the environmental sampling information from the one or more modular environmental sampling sensors, receive the positioning information from the positioning sensor, determine, based on the environmental sampling information and the positioning information, if an alert is to be presented to the worker, and provide the output signal to the one or more output devices if the one or more environmental conditions necessitates the alert be presented to the worker, the controller being further configured to determine, based at least in part on the environmental sampling information, whether to wirelessly transmit an alert to a second wearable device worn by a second worker, indicative of the worker being in need of aid.

15. The wearable device of claim 14, wherein the wearable article is a wrist band configured to be worn on an arm of the worker.

16. The wearable device of claim 15, wherein the wearable article is a modular sleeve configured to be worn on an arm of the worker.

17. The wearable device of claim 15, wherein the wearable article is a belt configured to be worn on a mid-section of the worker.

18. The wearable device of claim 15, wherein the wearable article is headwear configured to be worn on a head of the worker.

19. A method for monitoring environmental conditions associated with a working environment in relation to a worker within the working environment, the method comprising:
monitoring the one or more environmental conditions using one or more environmental sampling sensors, each of the one or more environmental sampling sensors being operatively associated with a wearable device configured to be worn by the worker within the working environment;
determining environmental sampling information based on the monitoring of the one or more environmental conditions using the one or more environmental sampling sensors;
determining positioning information for the worker using a positioning sensor operatively associated with the wearable device, the positioning information including information regarding positioning of the worker relative to the working environment;
receiving, by a controller having a processor, the environmental sampling information from the environmental sampling sensors;
receiving, by the controller, the positioning information from the positioning sensor;
determining, by the controller, if the one or more environmental conditions necessitates an alert be presented to the worker, based on the environmental sampling information and the positioning information;
providing the alert to the worker if the one or more environmental conditions necessitates the alert be presented to the worker;
determining by the controller, based at least in part on the environmental sampling information, whether to provide an alert to a second worker wearing a second wearable device, that the worker is in need of aid; and
if it is determined that an alert is to be provided to the second worker, transmitting the alert to the second wearable device.

20. (canceled)
